(19) United States
(12) Patent Application Publication
(10) Pub. No.: US 2015/0067884 A1
(43) Pub. Date: Mar. 5, 2015

(54) METHOD AND SYSTEM FOR PROTECTING SOFTWARE

(71) Applicant: Beijing TEAMSUN Software Technology Co., Ltd., Beijing (CN)

(72) Inventor: DAHAI WANG, Beijing (CN)

(73) Assignee: Beijing TEAMSUN Software Technology Co., Ltd., Beijing (CN)

(21) Appl. No.: 14/260,089

(22) Filed: Apr. 23, 2014

(30) Foreign Application Priority Data
Aug. 28, 2013 (CN) 201310381864.8

(51) Int. Cl. G06F 21/10

(52) U.S. Cl. CPC G06F 21/105
USPC 726/27

(57) ABSTRACT

Provided is a method for protecting software. Software license information of an authorized user is used to generate an identifying code of software license. The identifying code of software license is analyzed by the software system of the authorized client terminal wherein the software license information and valid period of said identifying code of software license. The software system of an authorized client terminal then determines whether the current time is within the validation time period. If the current time is within the validation time period, then the protected software is enabled.

### CROSS-REFERENCE TO RELATED APPLICATIONS

This application claims priority to and/or benefit from Chinese Application No. 201310381864.8, filed on Aug. 28, 2013, entitled “METHOD AND SYSTEM FOR PROTECTING SOFTWARE,” the specification of which is incorporated by reference herein in its entirety.

### TECHNICAL FIELD

The present disclosure relates to the field of computer software technology, and more particularly to a method and a system for protecting software.

### BACKGROUND

An identifying code of software license refers to a character string or a document which detects the validity of computer software during the running of the computer software, thereby determining whether all of or part of functions of the computer software can be normally executed. The normal running of computer software controlled by an identifying code of software license relies on a valid identifying code of software license.

Generally, an identifying code of software license is generated according to information of a software license, and has a one-to-one relationship with the software license. As long as the software license is valid, the computer software can be run using a valid identifying code of software license. Therefore, once the identifying code of software license is generated, the user of the software can repeatedly use it. Even if the computer software is re-installed, the corresponding functions of the computer software can be enabled at any time through the previously generated identifying code of software license.

Using the identifying code of software license, which has a one-to-one relationship with the software license, if the software license doesn't have a compulsory binding relationship with the device running the software, i.e., the authorized device, once the identifying code of software license is obtained by an unauthorized user, the unauthorized user can, at any time and on any device capable of running the software, enable the corresponding functions of the software through the identifying code of software license, forming an unauthorized use of the software.

Even if the software license has a compulsory binding relationship with the device running the software legally, wherein the identifying code of software license is valid only when the feature of the device running the software herein conforms to the feature of the authorized device, and the feature is an unique feature of the authorized device, which may be an IP address, hardware physical address or serial number, and so on, once an unauthorized user obtains the identifying code of software license, the unauthorized user still has enough time to forge the feature of an unauthorized device into the feature of the authorized device, thereby forming unauthorized use of the software.

As seen from the above, how to prevent an unauthorized user from illegally using software by means of copying the identifying code of software license and copying software system information of an authorized client terminal, is a problem urgently needed to be addressed.

### SUMMARY

In view of the defects existing in the prior art mentioned above, in one aspect, the present disclosure provides a method for protecting software, which can solve the problem enabling an unauthorized user can illegally use software by means of copying the identifying code of software license and copying software system information of an authorized client terminal.

A method for protecting software comprises the following steps:
according to software license information of authorized user, generating an identifying code of software license, which corresponds to said software license information and has a valid period;
analyzing said identifying code of software license by a software system of authorized client terminal, acquiring said software license information and valid period of said identifying code of software license;
judging whether current time is within said valid period by said software system of authorized client terminal, acquiring a judging result; and
according to said judging result, if said current time is within said valid period, then outputting said software license information, enabling corresponding function of software, if not, then returning failure information.

According to one embodiment, prior to said step of according to software license information of authorized user, generating an identifying code of software license, which corresponds to said software license information and has a valid period, said method further comprises:
generating said software license information according to software using information of said authorized user, and then saving said software license information.

According to one embodiment, after the step of generating said software license information according to software using information of said authorized user, and then saving said software license information, said method further comprises:
when a user applying for said identifying code of software license, judging whether there exists said software license information corresponding to said identifying code of software license according to application information of the identifying code herein provided by said user; if there exists said software license information corresponding to said identifying code of software license, then generating an identifying code of software license, if not, then returning information that the application information for the identifying code herein is illegal.

According to one embodiment, prior to the step of analyzing said identifying code of software license by a software system of authorized client terminal, acquiring said software license information and valid period of said identifying code of software license, said method further comprises:
judging whether said identifying code of software license is valid by said software system of authorized client terminal, if it is, then going to the next step for further judging the identifying code of software license; if not, then returning information that the identifying code of software license is illegal.

According to one embodiment, said valid period is composed of a generating time of identifying code of software license and a valid duration, or composed of a generating time of identifying code of software license and a using end time of identifying code of software license.

According to one embodiment, said step of returning failure information comprises: prompting that said identifying code of software license is expired.

In another aspect, the present disclosure provides a system for protecting software; said system comprises an identifying code generating module, an analyzing module, a time judging module and an executing module, wherein:
said identifying code generating module is configured to, according to software license information of authorized user, generate an identifying code of software license, which corresponds to said software license information and has a valid period;
said analyzing module is configured to analyze said identifying code of software license, acquire said software license information and valid period of said identifying code of software license;
said time judging module is configured to judge whether current time is within said valid period, and acquire a judging result;
said executing module is configured to, according to said judging result, if said current time is within said valid period, then output said software license information, and enable corresponding function of software, if not, then return failure information.

According to one embodiment, said system further comprises a storing module, wherein, said storing module is configured to generate said software license information according to software using information of said authorized user, and then save said software license information.

According to one embodiment, said system further comprises a license information searching module and an identifying code generation judging module, wherein:
said license information searching module is configured to, when a user applies for said identifying code of software license, judge whether there exists said software license information corresponding to said identifying code of software license according to application information of the identifying code herein provided by said user;
said identifying code generation judging module is configured to, if there exists said software license information corresponding to said identifying code of software license, then generate an identifying code of software license, if not, then return information that the application information for the identifying code herein is illegal.

According to one embodiment, said system further comprises an identifying code judging module, wherein said identifying code judging module is configured to judge whether said identifying code of software license is valid, if it is, then go to the next step for further judging the identifying code of software license; if not, then return information that the identifying code of software license is illegal.

Preferably, according to one embodiment, said valid period is composed of a generating time of identifying code of software license and a valid duration, or composed of a generating time of identifying code of software license and using an end time of identifying code of software license.

The present disclosure has following advantages:

According to the method and system for protecting software of the present disclosure, by using an identifying code of software license including a valid period, the software can be prevented effectively from being installed and used randomly and indefinitely by an unauthorized user, after the unauthorized user illegally obtains the identifying code of software license. Even if an unauthorized user illegally obtains the identifying code, since the unauthorized user doesn't know the valid period of the identifying code obtained, the unauthorized user can't run the software by means of changing the system time. Therefore, as compared with conventional identifying code of software license, the identifying code of software license with a valid period can protect the software better. In the case that the software license is valid, by means of including the valid period information of the identifying code itself in the identifying code herein, the method and system for protecting software are achieved which can distribute and identify the identifying code of software license in the way of instantly applying, instantly releasing, instantly using, and becoming invalid after expiry time, thereby greatly reducing the risk of unauthorized using of software due to leaking of the identifying code.

### BRIEF DESCRIPTION OF THE DRAWINGS

FIG. 1 is a flow diagram illustrating the method for protecting software according to one embodiment of the present invention;

FIG. 2 is a system structure diagram illustrating the system for protecting software according to one embodiment of the present invention.

### DETAILED DESCRIPTION

In order to make the purpose, technical solutions and advantages of the present disclosure to be understood more clearly, the method and system for protecting software of the present disclosure will be described in further details with the accompanying drawings and the following embodiments. It should be understood that the specific embodiments described herein are merely examples to illustrate the disclosure, not to limit the present disclosure.

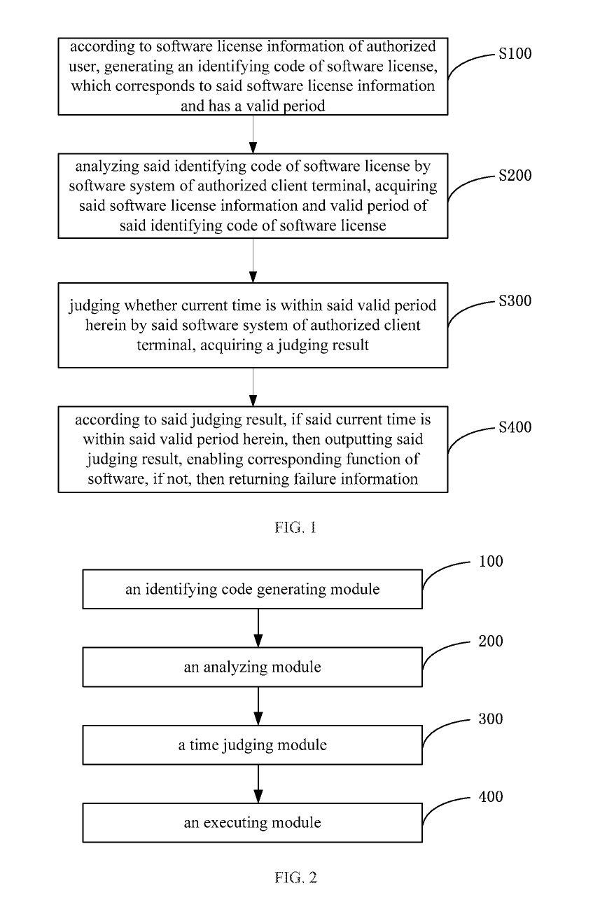

In one embodiment as shown in FIG. 1, the method for protecting software includes following steps:
Step 100: according to software license information of authorized user, generating an identifying code of software license, which corresponds to said software license information and has a valid period.

Each authorized software user has corresponding software license information, the software user can enable all of or part of the functions of the authorized software as long as said software license information is acquired, and how many functions of the software can be enabled depends on an agreement between the software user and the releaser of software license. According to the software license information of the authorized user, an identifying code generator generates an identifying code including software license information (that is, the identifying code is corresponding to the software license information), e.g., by means of conventional methods for generating an identifying code of software license, simultaneously, the identifying code of software license generated herein also includes a valid period.

Said valid period refers to that, the identifying code of software license should be used within a certain period, and will be expired beyond the preset period, then the corresponding or included software license information can no longer be acquired through the identifying code herein, and therefore, the function of corresponding software can't be enabled.

Through using an identifying code of software license including a valid period, the method mentioned above can effectively prevent an unauthorized user from installing and using the software randomly and indefinitely, after an unauthorized user illegally obtains the identifying code of software license.

Even if an unauthorized user obtains the identifying code of software license, since the valid period of the identifying code obtained herein can't be determined; the unauthorized user can't run the software by means of changing the system time. Therefore, as compared with conventional identifying code of software license, the identifying code with a valid period of the present disclosure can protect the software better.

Preferable, in one embodiment of the present invention, the valid period of the identifying code is composed of a generating time and a valid duration.

In this embodiment, S100 specifically includes following steps:
S110: reading software license information of the authorized user;
S120: reading current system time as the generating time of identifying code of software license, and presetting the valid duration of identifying code of software license;
S130: generating the identifying code of software license, which corresponds to said software license information and includes a generating time and valid duration.

In this embodiment, the generating time of the identifying code is the same as the system time of generating the identifying code, said valid duration (validation period) is determined according to the agreement between the software user and the releaser of software license, which may be set as several minutes, several hours or several days.

After being generated, the identifying code of software license is valid between the generating time and the end of the valid duration or validation period, that is, the authorized user can enter the identifying code, acquire software license information, and enable the corresponding function of the software within this period.

As another embodiment of the present invention, the valid period of identifying code herein includes a generating time and a using end time of identifying code of software license.

In this embodiment, the identifying code of software license is valid for validating use of the software between the generating time and the using end time of identifying code of software license, the software license information can't be acquired through the identifying code of software license beyond the period, and the corresponding function of the software can't be enabled.

S200: analyzing said identifying code of software license by software system of authorized client terminal, acquiring said software license information and valid period of said identifying code of software license.

After receiving the identifying code of software license released by the identifying code generator releaser, the authorized user enters said identifying code of software license in the software system of authorized client terminal, then corresponding license processing program analyzes said identifying code entered herein, and acquires the included software license information and valid period of the identifying code itself.

It should be illustrated here that, the process of analyzing said identifying code of software license and acquiring the software license information by the software system of authorized client terminal, is realized by conventional methods for identifying software license, which is not described in details here.

Said valid period may be composed of a generating time of the identifying code and valid duration, or may be composed of a generating time and a using end time of the identifying code.

S300: judging whether current time is within said valid period herein by said software system of authorized client terminal, acquiring a judging result.

After analyzing the valid period of the identifying code itself including the identifying code of software license, the software system of authorized client terminal reads current system time, and judges whether the current system time is within the valid period of the identifying code analyzed herein, that is, judges whether the current system time is within the period between the generating time and the end of the valid duration (i.e., validation duration) of the identifying code, or within the period between the generating time and the using end time of the identifying code.

S400: according to said judging result, if said current time is within said valid period herein, then outputting said judging result, enabling corresponding function of software, if not, then returning failure information.

According to the comparison between the system and the valid period of the identifying code, if current system time is within the valid period of identifying code herein, the software license information is outputted, which is corresponding to the identifying code of software license, and the function of the software, corresponding to the software license information, is enabled according to the software license information; if the current system time is not within the valid period of the identifying code herein, failure information is returned, and no function of the software will be enabled.

Thus, in the case that the software license is valid, by means of including the valid period information of the identifying code itself in the identifying code herein, the method for protecting software is achieved which can distribute and identify the identifying code of software license in the way of instantly applying, instantly releasing, instantly using, and becoming invalid after expiry time, thereby greatly reducing the risk of unauthorized using of software due to leaking of the identifying code.

As a preferred embodiment, said failure information returned herein may be a sentence such as “the identifying code is expired”.

As a preferred embodiment, prior to the step S100, the method further includes following steps:
S010: according to software using information of said authorized user, generating said software license information by conventional methods of generating software license, and then saving said software license information.

According to the software using information of the authorized user, including information of software user, name of software, version information of software, running environment information of software, additional constraints and other effective information needed for authorizing the use of said software, the releaser of the software license and the identifying code of software license generates software license information by conventional methods of generating software license, and saves the software license information generated herein, so as to be convenient for generating corresponding identifying code of software license according to the software license information in subsequent processes, also for verifying in the future.

In various embodiments before the step of S100 and after the step of S010, the method further includes following steps:
S020: when a user applies for said identifying code of software license, according to application information of the identifying code therein provided by said user, judging whether there exists said software license information corresponding to said identifying code of software license;
S030: if there exists said software license information corresponding to said identifying code of software license, then generating an identifying code of software license, if not, then returning information that the application information for the identifying code herein is illegal.

When the user applies for an identifying code of software license, according to application information provided by the user, the releaser of the identifying code searches the software license information corresponding to the application information provided herein; if there is saved software license information, which basically illustrates that the user is an authorized user, then the identifying code generator continues to generate the identifying code of software license, if not, then the information, that the application information for the identifying code herein is illegal, is returned. Through saving and searching the software license information, the software is protected from another aspect, thereby preventing the unauthorized user from applying for identifying code of software license through software license information obtained illegally.

It needs to be illustrated here that, the application information about identifying code of software license provided by the user, should be all or part information of the set of using information of authorized user, when the user provides part information, the part information should be sufficient for determining whether there exists corresponding software license information.

In case the authorized user needs to re-install and deploy the software, when the user needs to re-input the license information, the releaser of the identifying code will directly execute the step S020 to search corresponding software license information, without the need of executing the step S010.

As a preferred embodiment, before the step S200, the method further includes the following step:
S2001: judging whether said identifying code of software license is valid by said software system of authorized client terminal, if it is, then going to the next step for further judging the identifying code of software license; if not, then returning information that the identifying code of software license is illegal.

Said software system of authorized client terminal judges whether said identifying code of software license is valid, if it is, then goes to the next step for further judging said identifying code herein; if not, then directly returns for re-entering the identifying code of software license, and outputs information that the identifying code of software license is illegal. In this way, the software is protected from the basic level, thereby preventing a software system of authorized client terminal from using the software by means of counterfeiting the identifying code.

According to the same inventive concept, a system for protecting software is provided, since the principle of solving problem of the system is similar as that of the method for protecting software mentioned above, the implementation of said system can be achieved with reference to the specific steps of the method mentioned above, wherein the repeated contents will not be described in details here.

According to one embodiment of the present invention as shown in FIG. 2, a system for protecting software includes an identifying code generating module 100, an analyzing module 200, a time judging module 300 and an executing module 400.

Said identifying code generating module 100 is configured to, according to software license information of authorized user, generate an identifying code of software license, which corresponds to said software license information and has a valid period.

Said valid period or validation period refers to that, the identifying code of software license should be used within a certain period, the identifying code of software license will be expired beyond the preset period of time, then the corresponding or included software license information can no longer be acquired through the identifying code herein, and the function of corresponding software can't be enabled.

In another embodiment, of the present invention, the valid period of the identifying code herein is composed of a generating time and valid duration. The generating time is the same as the system time when the identifying code is generated, said preset valid period of the identifying code of software license is determined according to the agreement between the authorized user and the releaser of the software license, the valid period may be set as several minutes, several hours or several days.

In another embodiment, of the present invention, the valid period of the identifying code herein includes a generating time and a using end time of the identifying code.

Said analyzing module 200 is configured to analyze said identifying code of software license, acquire said software license information and valid period of said identifying code of software license.

Said time judging module 300 is configured to judge whether current time is within said valid period herein, and acquire a judging result;

Said executing module 400 is configured to, according to said judging result, if said current time is within said valid period herein, then output said judging result, enable corresponding function of software, if not, then return failure information.

In some embodiments, said failure information returned herein may be a sentence such as “the identifying code is expired”.

By means of using an identifying code of software license including a valid period, the software can be prevented from being installed and used randomly and indefinitely after a software system of unauthorized user terminal illegally obtains the identifying code of software license.

Even if the software system of unauthorized user terminal obtains the identifying code of software license, since the valid period of the identifying code obtained herein can't be determined; the software system of unauthorized user terminal can not run the software by means of changing the system time. Therefore, as compared to conventional identifying code of software license, the identifying code with a valid period of the present invention can protect the software better.

According to the comparison between the system time and the valid period of the identifying code, if current system time is within the valid period of identifying code herein, the software license information corresponding to the identifying code of software license is output, and the function of the software, corresponding to the software license information, is enabled according to the software license information; if the current system time is not within the valid period of the identifying code herein, failure information is returned, and no function of the software will be enabled.

Thus, in the case that the software license is valid, by means of including the valid period information of the identifying code itself in the identifying code herein, the system for protecting software is achieved which can distribute and identify the identifying code of software license in the way of instantly applying, instantly releasing, instantly using, and becoming invalid after expiry time, thereby greatly reducing the risk of unauthorized using of software due to leaking of the identifying code.

In embodiments, the system for protecting software mentioned above further includes a storing module, a license information searching module and an identifying code generation judging module, wherein:
the storing module is configured to, according to software using information of said authorized user, generate said software license information by conventional methods of generating software license, and then save said software license information;
the license information searching module is configured to, when a user applying for said identifying code of software license, according to application information of the identifying code herein provided by said user, judge whether there exists said software license information corresponding to said identifying code of software license; and
the identifying code generation judging module is configured to, if said software license information corresponding to said identifying code of software license exists, then generate an identifying code of software license, if not, then return information that the application for the identifying code herein is illegal.

In various embodiments, the system for protecting software mentioned above further includes an identifying code judging module, which is configured to judge whether said identifying code of software license is valid, if it is, then go to the next step for further judging the identifying code of software license; if not, then return information that the identifying code of software license is illegal.

Said identifying code judging module judges whether said identifying code of software license is valid, if it is, then goes to the next step for further judging the identifying code of software license; if not, then directly returns for re-entering the identifying code of software license, and outputs information that the identifying code of software license is illegal. In this way, the software is protected from the basic level, thereby preventing said software from being used by an authorized client by means of counterfeiting the identifying code.

The foregoing examples are preferred embodiments of the present invention only and not intended to limit the present disclosure. It should be understood that, to the person skilled in the art, various modifications and improvements can be made without departing from the spirit and principle of the present disclosure, which should all be included within the scope of the present disclosure. Therefore, the protection scope of the present disclosure shall be defined by the appended claims.

What is claimed is:

1. A method for protecting software, comprising:
generating, by an identifying code generator module in association with a software, an identifying code of software license comprising software license information that corresponds to a particular software license between an authorized user and a software releaser of the software, and a validation period, wherein the validation period is a preset time period during which the authorized user can enable the software on an authorized client terminal;
providing the software identifying code of software license to the authorized user for entry into the authorized client terminal;
analyzing, by an analyzing module on the authorized client terminal, the identifying code of software license, and determining the software license information and the validation period of the identifying code of software license;
judging, by a time judging module on the authorized client terminal, whether a current time is within the validation period;
when the current time is within the validation period, then enabling an execution module configured to enable functions of the software on the authorized client terminal in accordance with the software license;
when the current time is outside of the validation period, then indicating a failure to enable the software.

2. The method for protecting software according to claim 1, wherein prior to generating, the method further comprises generating, by the software releaser, the software license information that corresponds to the particular software license between the authorized user and the software releaser; and saving the software license information by the software releaser.

3. The method for protecting software according to claim 2, wherein, after the step of generating by the software releaser, the method further comprises:
receiving a request from the authorized user for another identifying code of software license so that the user can re-install the software on an authorized client terminal, the request comprising the identifying code of software license and an authorized user information corresponding to the software license;
determining, using the identifying code of software license and the authorized user information, whether the software license information that corresponds to the particular software license between the authorized user and the software releaser already exists;
when it is determined that the software license information that corresponds to the particular software license already exits, then generating a corresponding identifying code of software license and providing the corresponding identifying code of software license to the authorized user for entry into the authorized client terminal; the corresponding identifying code of software license comprises the software license information that corresponds to the particular software license between the authorized user and the software releaser, and a new validation period;
when it is determined that there is no software license information that corresponds to the particular software license, then providing information indicating that the request for another identification code of software license is not valid.

4. The method for protecting software according to claim 1, wherein, prior to the step of analyzing the method further comprises:
judging, by the software of the authorized client terminal, whether the identifying code of software license is valid, when the identifying code of software is valid, then going to the next judging step; when the identifying code of software is not valid, then returning information indicating that the identifying code of software license is not valid.

5. The method for protecting software according to claim 3, wherein, prior to the step of analyzing, the method further comprises:
judging whether corresponding identifying code of software license is valid by the software on the authorized client terminal, if it is valid, then going to the next step; if it is not valid, then indicating that the corresponding identifying code of software license is not valid.

6. The method for protecting software according to claim 1, wherein the validation period is a preset time period beginning at a time that the identifying code of software license was generated and ended after a predetermined duration, or is a preset time period beginning at a generating time ending at an end time.

7. The method for protecting software according to claim 3, wherein, the new validation period is a preset time period beginning at a time that the identifying code of software license was generated and ended after a predetermined duration, or is a preset time period beginning at a generating time ending at an end time.

8. The method for protecting software according to claim 1, wherein, providing information indicating that the request for another identification code of software license is not valid further comprises prompting that the identifying code of software license is expired.

9. A system for protecting software, comprising:
an identifying code generating module configured to, in accordance with software license information corresponding to an authorized user of a software on an authorized client terminal, generate an identifying code of software license that corresponds to the software license information and comprises a validation time period within which the authorized user must initially validate the software on the authorized client terminal by entering the identifying code of software license, the identifying code generating module further configured to initialize providing the authorized user with the identifying code of software license when applied for by the authorized user;
an analyzing module, on the authorized client terminal, configured to analyze the identifying code of software license in order to acquire the software license information and the validation period of the identifying code of software license;
a time judging module configured to determine whether an input time that the identifying code of software license is entered into the authorized client terminal is within the validation time period, and to provide a time judging result; and
an execution module configured to enable certain functions of the software when the time judging result indicates that the input time is within the validation period, and further configured to return a failure indication when the time judging result indicates that the input time is not within the validation period.

10. The system for protecting software according to claim 9, further comprising a storing module configured to generate the software license information according to software user information of the authorized user, and further configured to save the software license information.

11. The system for protecting software according to claim 10, further comprising:
a license information searching module and an identifying code generation judging module,
a license information searching module configured to determine whether the software license information already exists that corresponds to the identifying code of software license when a user applies with the identifying code of software license along with application information associated with the identifying code of software license previously provided by the user; and
an identifying code generation judging module configured to generate a new identifying code of software license when the license information that corresponds to the identifying code of software license already exists, and configured to provide the new identifying code of software license to the user, the new identifying code of software corresponds to the software license information and comprises a new validation time period within which the authorized user must re-validate the software on the authorized client terminal by entering the new identifying code of software license; the identifying code generation judging module further configured to provide an indication that the identifying code of software license is invalid when license information corresponding to the identifying code of software license and user provided application information does not already exists.

12. The system for protecting software according to claim 9, further comprising:
an identifying code judging module configured to determine whether the identifying code of software license is a valid identifying code of software license, and to provide an identifying code judging result, when the identifying code judging result; and
wherein the execution module is further configured to enable the certain functions of the software when the identifying code judging result indicates that the identifying code of software is valid, and further configured to return a failure indication when the identifying code judging result indicates that the identifying code of software is not valid.

13. The system for protecting software according to claim 9, wherein, the validation period is a preset time period beginning at a time that the identifying code of software license was generated and ended after a predetermined duration, or is a preset time period beginning at a generating time ending at an end time.
